(19) United States
(12) Patent Application Publication
(10) Pub. No.: US 2012/0047660 A1
(43) Pub. Date: Mar. 1, 2012

(54) FOLDING KNIFE

(76) Inventor: Victor Lee, New York, NY (US)

(21) Appl. No.: 12/868,493

(22) Filed: Aug. 25, 2010

(51) Int. Cl. B26B 11/00; B23P 19/04

(52) U.S. Cl. 7/161; 29/700

(57) ABSTRACT

An apparatus including a housing, and a knife connected to the housing, wherein the knife at least partially folds into the housing. The apparatus also may include a first device for cracking a vehicle windshield, wherein the first device is connected to the housing. The apparatus may also include a second device for cutting a vehicle seat belt, wherein the second device is connected to the housing and at least partially folds into the housing. The knife may be connected to the housing so that the knife rotates in order to at least partially fold into the housing. The first device may include a first spring so that the first device can be compressed into the housing or expanded away from the housing. The second device may be connected to the housing so that the second device rotates in order to at least partially fold into the housing.

### FIELD OF THE INVENTION

This invention relates to improved methods and apparatus concerning folding knives.

### BACKGROUND OF THE INVENTION

There are various devices known in the prior art for folding knives.

### SUMMARY OF THE INVENTION

At least one or more embodiments of the present invention provide an apparatus comprising a housing, a knife connected to the housing, wherein the knife at least partially folds into the housing, and a first device for cracking a vehicle windshield, wherein the first device is connected to the housing. The apparatus may also include a second device for cutting a vehicle seat belt, wherein the second device is connected to the housing and at least partially folds into the housing. The knife may be connected to the housing so that the knife rotates in order to at least partially fold into the housing.

The first device may include a first spring so that the first device can be compressed into the housing or expanded away from the housing. The second device may be connected to the housing so that the second device rotates in order to at least partially fold into the housing. The first device may include a first member, and wherein the first device is configured with respect to the housing so that in a rest state, the first member protrudes out from the housing. The first device may be configured with respect to the housing so that a force can be applied to the first member which pushes the first member at least partially into the housing and which causes the first spring to compress. The first device may include a second member, wherein the first member is connected to the second member and the first member is configured to slide into the second member when the force is applied to the first member which pushes the first member at least partially into the housing. The first member may be substantially cylindrical and the second member may be substantially cylindrical. The second device for cutting a seat belt may include a U-shaped cutting edge located within an interior of a hook.

At least one embodiment of the present invention may also include a method comprising gripping an apparatus using a person's hand, and hitting a vehicle windshield with the apparatus while gripping the apparatus using the person's hand. The method may further include cutting a vehicle seat belt using a second device of the apparatus.

### BRIEF DESCRIPTION OF THE DRAWINGS

FIG. 1 shows a top, front, left side perspective view of a folding knife in accordance with an embodiment of the present invention wherein the folding knife is in a first state in which a device extends out from an overall housing while a blade is in a closed position;

FIG. 2 shows a top, front, left side perspective view of the folding knife of FIG. 1, wherein the folding knife is in a second state, with the blade shown extending from an overall housing of the folding knife while the device is in a closed position;

FIG. 3 shows a bottom planar orthogonal view of the folding knife of FIG. 1 with the folding knife in a third state such that the blade and the device are in a closed position;

FIG. 4 shows a top planar orthogonal view of the folding knife of FIG. 1 with the folding knife in the second state of FIG. 2, with the blade extending from the overall housing of the folding knife and the device in a closed position;

FIG. 5 shows a top planar orthogonal view of the folding knife of FIG. 1 with the folding knife in the first state of FIG. 1, with the device extending from the overall housing of the folding knife, while the blade is in a closed position;

FIG. 6 shows a front planar orthogonal view of the folding knife of FIG. 1 with the folding knife in the first state of FIG. 1;

FIG. 7 shows a rear planar orthogonal view of the folding knife of FIG. 1 with the folding knife in the first state of FIG. 1;

FIG. 8 shows a right side planar orthogonal view of the folding knife of FIG. 1 with the folding knife in the second state of FIG. 2;

FIG. 9 shows a left side planar orthogonal view of the folding knife of FIG. 1 with the folding knife in the second state of FIG. 2;

FIG. 10 shows a right side planar orthogonal view of the folding knife of FIG. 1 with the folding knife in the first state of FIG. 1;

FIG. 11 shows a left side planar orthogonal view of the folding knife of FIG. 1 with the folding knife in the first state of FIG. 1;

FIG. 12 shows a perspective view of the underside of a top plate or section of the folding knife of FIG. 1 and a perspective view of a cylindrical component and spring of the folding knife of FIG. 1, with the cylindrical component in a non-compressed state;

FIG. 13 shows a perspective view of the cylindrical component of FIG. 12, with the cylindrical component in a compressed state;

FIG. 14A shows a perspective view of the inside of a bottom plate or section of the folding knife of FIG. 1 with the cylindrical component and the spring of FIG. 12 inserted into the bottom plate or section and with the cylindrical component in a non compressed state;

FIG. 14B shows a perspective view of the inside of the bottom plate or section of FIG. 14A with the cylindrical component and the spring of FIG. 12 inserted into the bottom plate or section and with the cylindrical component in a compressed state;

FIG. 15 shows a perspective view of the folding knife with the folding knife taken apart;

FIG. 16A shows bottom view of the folding knife gripped by a human hand and applied with force to a glass window of a vehicle with the cylindrical component of FIG. 12 shown in a non-compressed state; and

FIG. 16B shows bottom view of the folding knife gripped by a human hand and applied with force to a glass window of a vehicle with the cylindrical component of FIG. 12 shown in a compressed state.

### DETAILED DESCRIPTION OF THE DRAWINGS

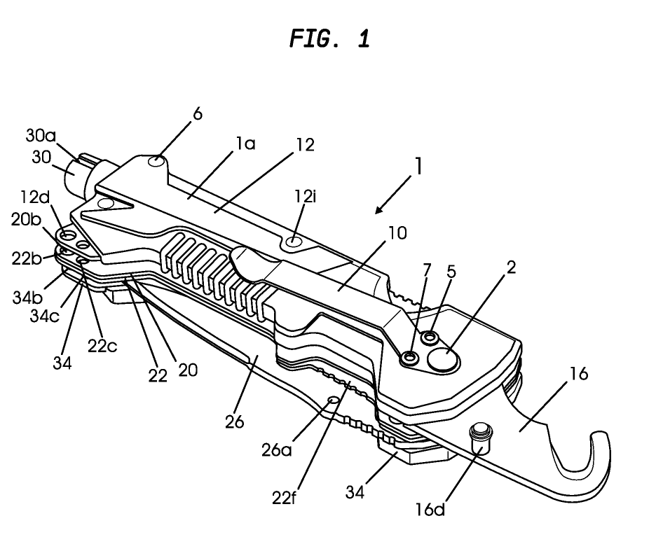

FIG. 1 shows a top, front, left side perspective view of a folding knife 1 in accordance with an embodiment of the present invention wherein the folding knife 1 is in a first state in which a device 16 extends out from an overall housing 1a while a blade 26 is in a closed position.

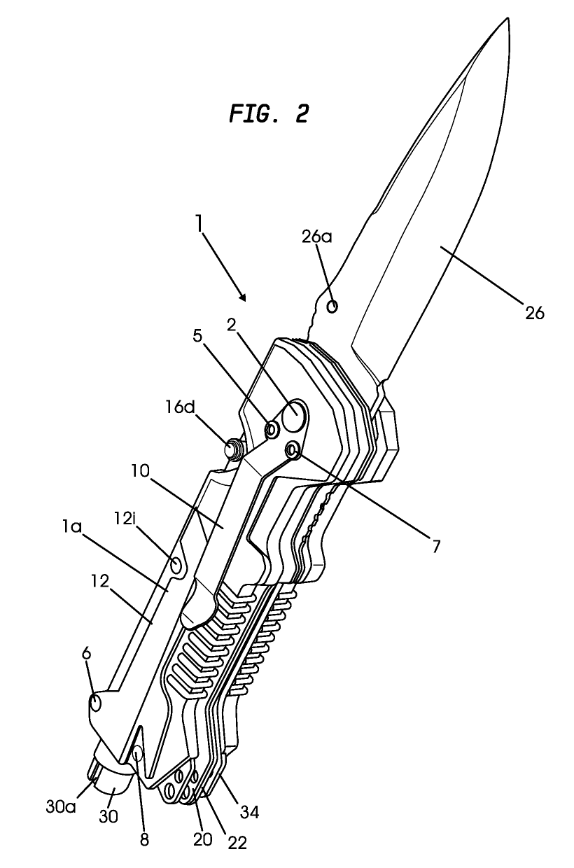

FIG. 2 shows a top, front, left side perspective view of the folding knife 1 of FIG. 1, wherein the folding knife 1 is in a second state, with the blade 26 shown extending from the overall housing 1a of the folding knife 1 while the device 16 is in a closed position.

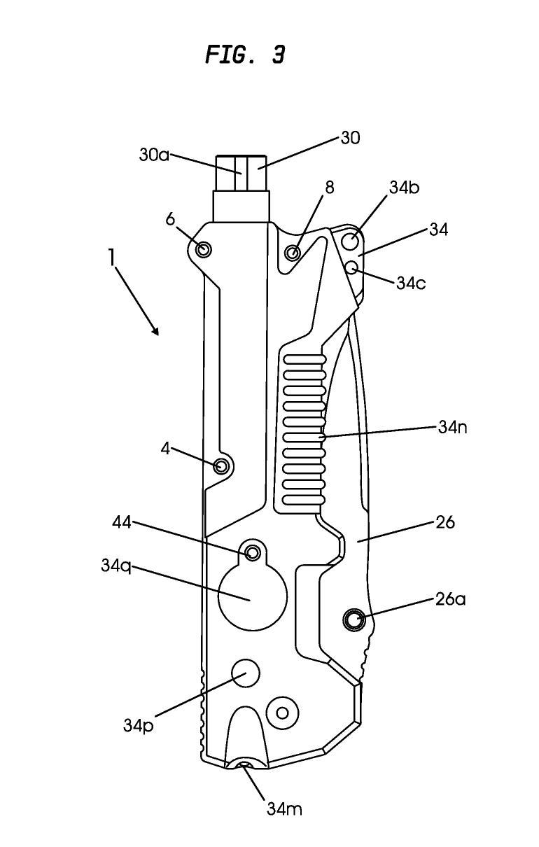

FIG. 3 shows a bottom planar orthogonal view of the folding knife 1 of FIG. 1 with the folding knife in a third state such that the blade 26 and the device 16 are in a closed position.

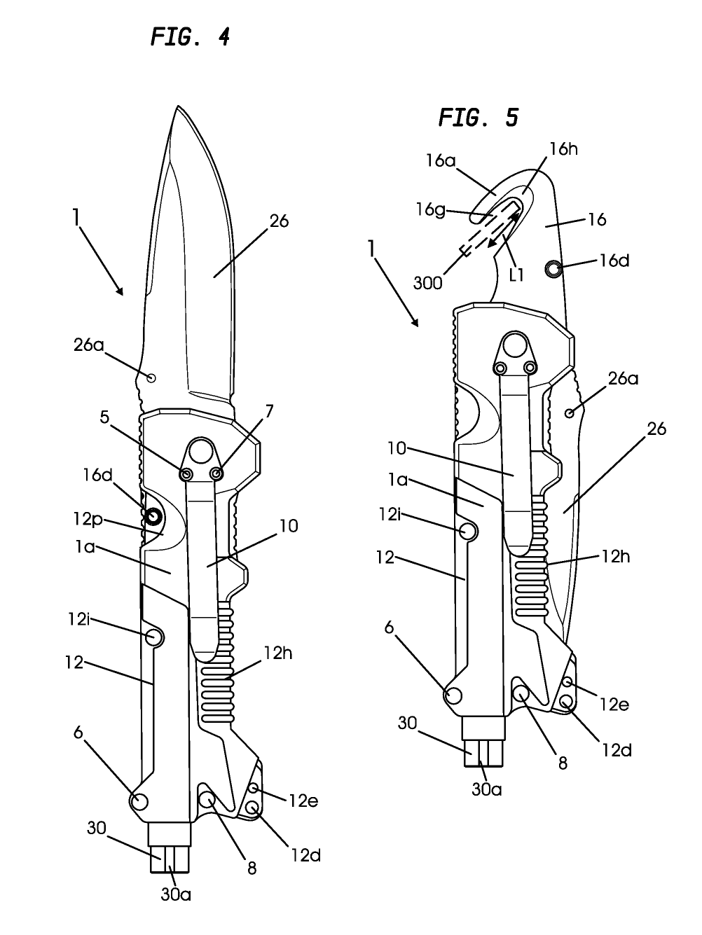

FIG. 4 shows a top planar orthogonal view of the folding knife 1 of FIG. 1 with the folding knife 1 in the second state of FIG. 2, with the blade 26 extending from the overall housing 1a of the folding knife 1 and the device 16 in a closed position.

FIG. 5 shows a top planar orthogonal view of the folding knife 1 of FIG. 1 with the folding knife 1 in the first state of FIG. 1, with the device 16 extending from the overall housing 1a of the folding knife 1, while the blade 26 is in a closed position;

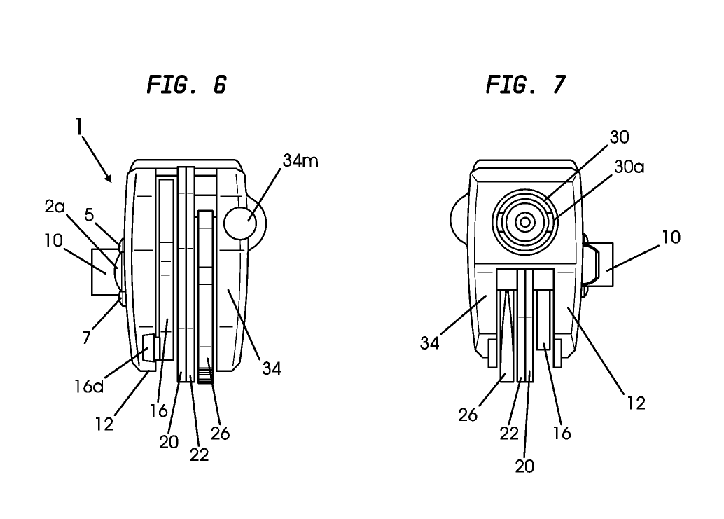

FIG. 6 shows a front planar orthogonal view of the folding knife 1 of FIG. 1 with the folding knife 1 in the first state of FIG. 1;

FIG. 7 shows a rear planar orthogonal view of the folding knife 1 of FIG. 1 with the folding knife 1 in the first state of FIG. 1;

FIG. 8 shows a right side planar orthogonal view of the folding knife 1 of FIG. 1 with the folding knife 1 in the second state of FIG. 2;

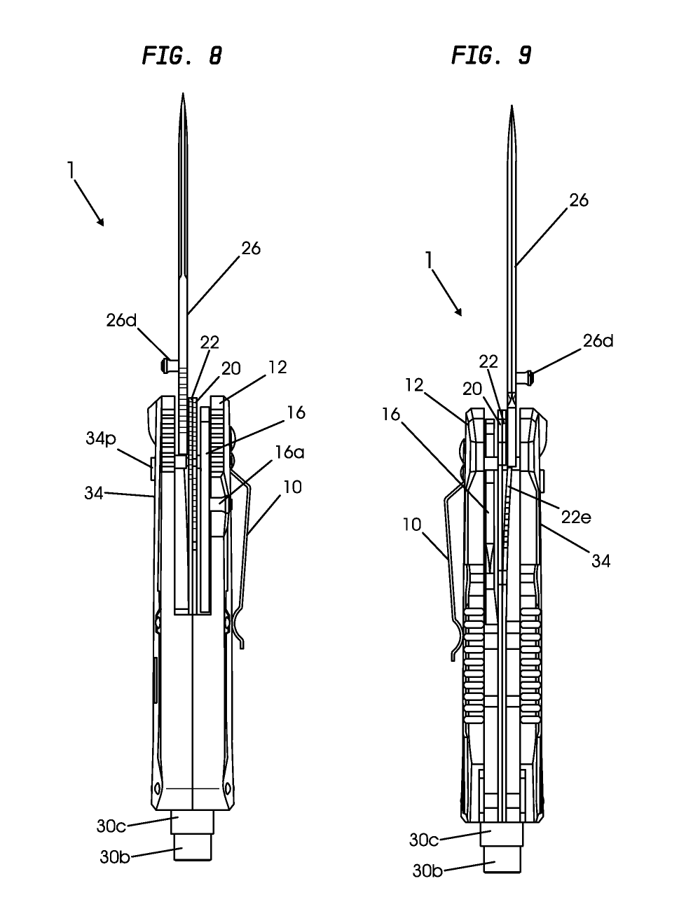

FIG. 9 shows a left side planar orthogonal view of the folding knife 1 of FIG. 1 with the folding knife 1 in the second state of FIG. 2;

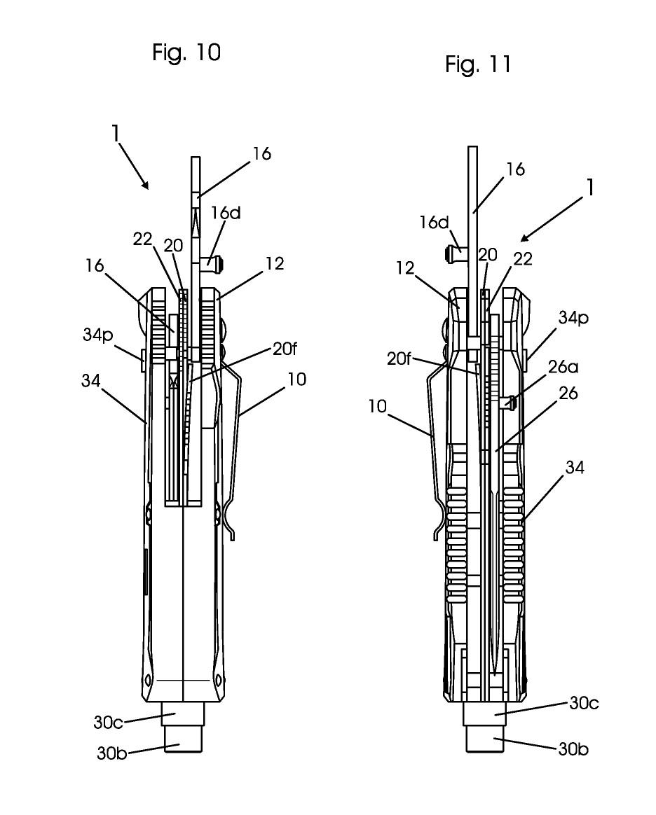

FIG. 10 shows a right side planar orthogonal view of the folding knife 1 of FIG. 1 with the folding knife 1 in the first state of FIG. 1;

FIG. 11 shows a left side planar orthogonal view of the folding knife 1 of FIG. 1 with the folding knife 1 in the first state of FIG. 1;

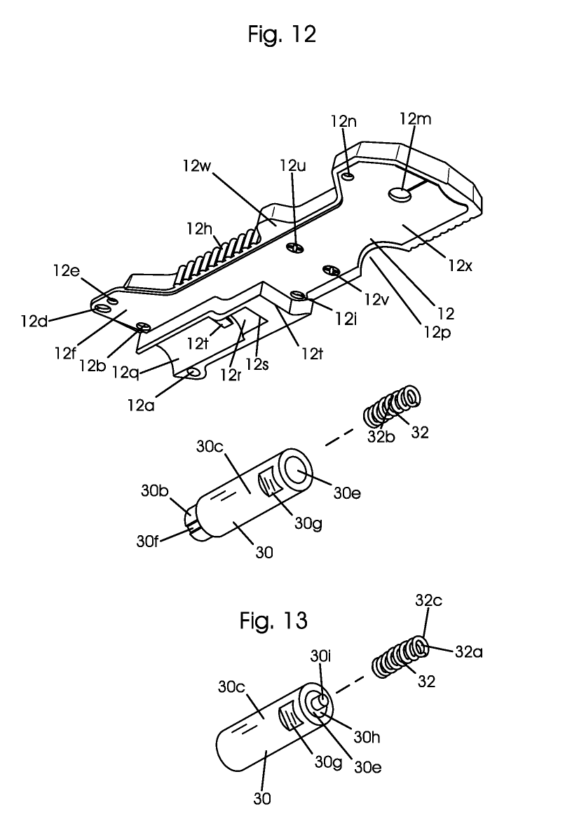

FIG. 12 shows a perspective view of the underside of a top plate or section 12 of the folding knife 1 of FIG. 1 and a perspective view of a cylindrical component 30 and a spring 32 of the folding knife 1 of FIG. 1, with the cylindrical component 30 in a non-compressed state;

FIG. 13 shows a perspective view of the cylindrical component 30 of FIG. 12, with the cylindrical component 30 in a compressed state;

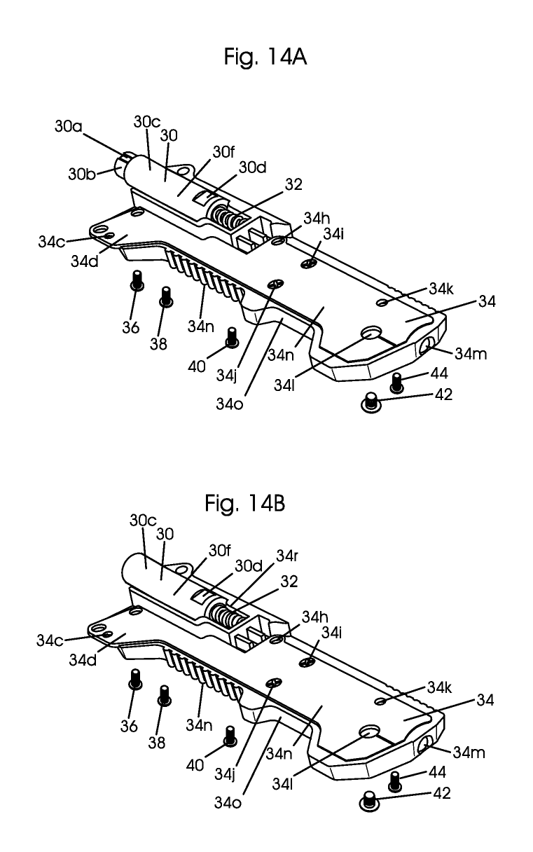

FIG. 14A shows a perspective view of the inside of a bottom plate or section 34 of the folding knife 1 of FIG. 1 with the cylindrical component 30 and the spring 32 of FIG. 12 inserted into the bottom plate or section 34 and with the cylindrical component 30 in a non compressed state;

FIG. 14B shows a perspective view of the inside of the bottom plate or section 34 of FIG. 14A with the cylindrical component 30 and the spring 32 of FIG. 12 inserted into the bottom plate or section 34 and with the cylindrical component 30 in a compressed state;

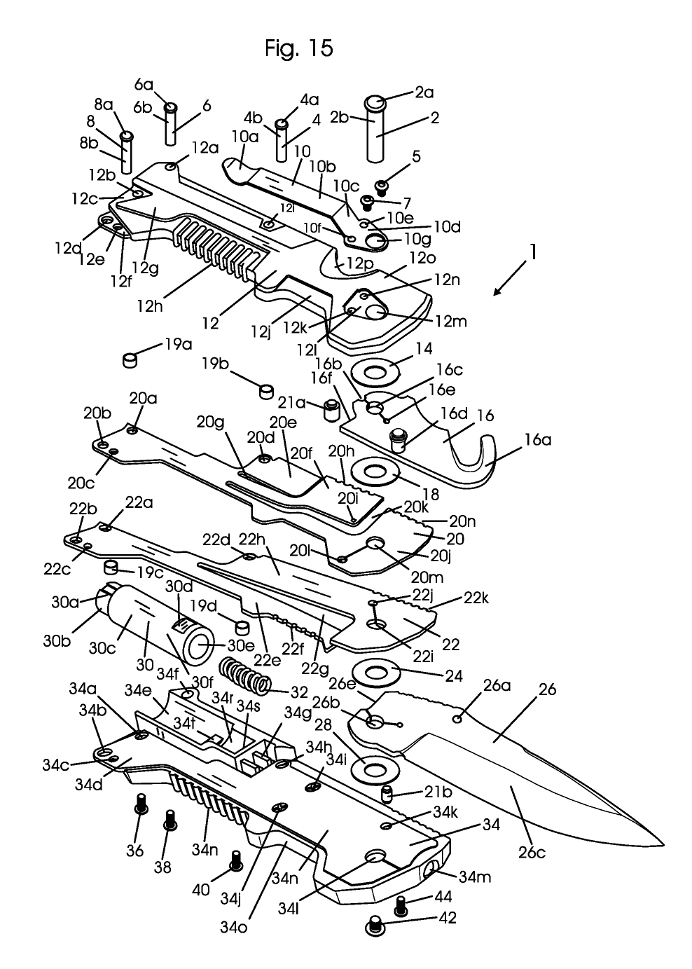

FIG. 15 shows a perspective view of the folding knife 1 with the folding knife 1 taken apart;

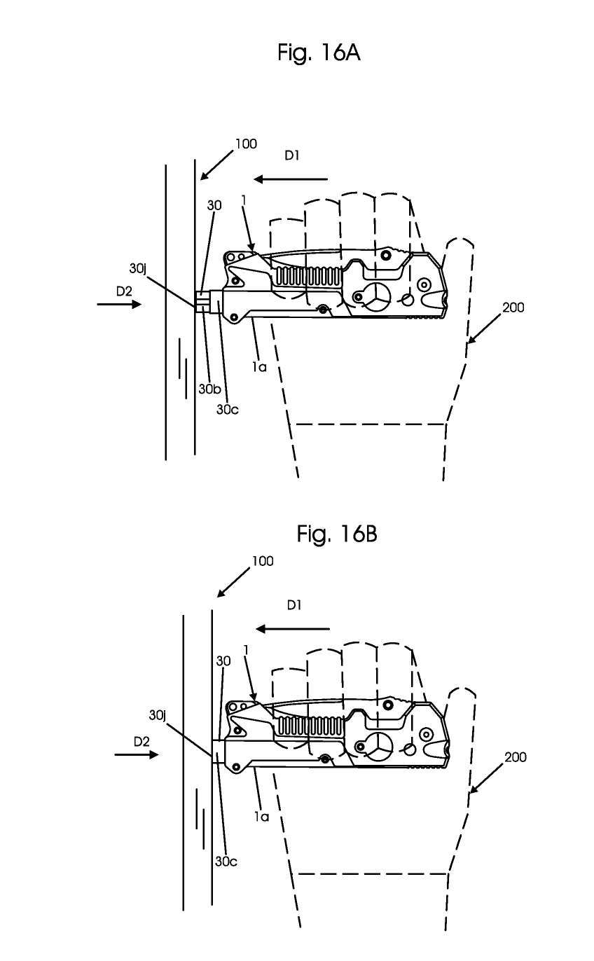

FIG. 16A shows bottom view of the folding knife 1 gripped by a human hand 200 of a human being and applied with force in a direction D1 to a glass window 100, such as a windshield, of a vehicle with the cylindrical component 30 shown in a non-compressed state; and

FIG. 16B shows bottom view of the folding knife 1 gripped by the human hand 200 of the human being and applied with force in the direction D1 to the glass window 100 of a vehicle with the cylindrical component 30 in a compressed state.

Referring to FIGS. 1-15 and particularly FIG. 15, the folding knife 1 includes pins 2, 4, 6, and 8, having top cap portions 2a, 4a, 6a, and 8a, and cylindrical body portions 2b, 4b, 6b, and 8b, respectively. Each of the top cap portions 2a, 4a, 6a, and 8a typically has a larger diameter than its corresponding cylindrical body portion of 2b, 4b, 6b, and 8b. Each of the pins 2, 4, 6, and 8 can be made of metal, such as steel. Each of the cylindrical body portions 2b, 4b, 6b, and 8b is hollow with an opening at an end opposite the respective cap portions 2a, 4a, 6a, and 8a, and typically closed at the opposing end of the respective cap portion 2a, 4a, 6a, and 8a. The inner walls of the cylindrical body portions 2b, 4b, 6b, and 8b have inner threads into which screws or bolts 42, 40, 38, and 36 are adapted to be screwed into, respectively, from the open ends.

The folding knife 1 also includes a clip 10. The clip 10 has a curved end 10a, a flat section 10b, a ramp or inclined section 10c, and a flat tapered section 10d. The flat tapered section 10d, has openings 10e and 10f into which screws or bolts 5 and 7, can be inserted, respectively, so that the threaded portions of the screws or bolts 5 and 7 fit through the openings 10e and 10f respectively, while the head or cap of the screws or bolts 5 and 7 do not fit through the openings 10e and 10f, respectively. The flat tapered section 10d also includes an opening 10g into which the cylindrical portion 2b of the pin 2 can be inserted. The cap or head portion 2a of the pin 2 cannot fit through the opening 10g. The clip 10 can be attached by screws 5 and 7 through holes 10e and 10f, and through threaded openings, bores, or indentations 12n and 12k of section or plate 12, respectively; and by cylindrical body portion 2b of pin 2 through hole 10g and hole 12m of section or plate 12 to the section or plate 12. The clip can be made of metal, such as stainless steel.

The folding knife 1 also includes the section or plate 12. The section or plate 12 has openings or bores 12a and 12b into which cylindrical body portions 6b and 8b can be inserted, but cap portions 6a and 8a cannot be inserted, respectively. The section or plate 12 also includes openings or bores 12i and 12m into which cylindrical body portions 4b and 2b can be inserted, but cap portions 4a and 2a cannot be inserted, respectively. The section or plate 12 also includes openings, bores or indentations 12n and 12k which may have inner threads such that threaded sections of screws or bolts 5 and 7 can be inserted into openings, bores or indentations 12n and 12k, respectively, to attach the clip 10 to the section or plate 12. The section or plate 12 also includes openings 12d and 12e, which may be for decorative purposes or to help align section or plate 12 with section or plates 20, 22, and 34.

The section or plate 12 also includes a plurality of ribs 12h which are useful for gripping the folding knife 1, such as for the purpose to be explained with reference to FIGS. 16A and 16B. The section or plate 12 also includes indented section 12l which has substantially the same shape as flat tapered section 10d so that flat tapered section 10d of the clip 10 can fit snugly into the indented section 12l for attaching the clip 10 to the section or plate 12 so that the clip 10 is secure and does not rotate. The section or plate 12 also includes raised section 12g indented sections 12c and 12j. The section may include a curved portion 12p which is curved so allow the device 16 to be closed as shown in FIG. 4, so that the post or protrusion 16d can fit within the substantially semicircular region defined by curved portion 12p.

The underside of section or plate 12 is shown in FIG. 12. As shown in FIG. 12, the section or plate 12 may be comprised of a metal plate 12x, which may be a steel metal plate, attached to a hard stiff outer housing, such as a hard plastic outer housing 12w by screws 12u and 12v. The section or plate 12, as shown by FIG. 12 also has indentation, hole or bore 12n, into which one end of a stopper or post 21a is inserted. The other end of the stopper or post 21a is inserted into opening 20l in plate or section 20. The stopper or post 21a is used to prevent the device 16 from rotating any further clockwise, as viewed in the drawing of FIG. 5, than the position shown in FIG. 5. The underside of section or plate 12 shown in FIG. 12 also shows a substantially half cylindrical cavity 12q, a protrusion 12t, and a half cylindrical cavity 12r. The half cylindrical cavity 12r terminates in at solid flat wall 12s. A device 30, shown in FIG. 12 is configured to at least partially fit within the half cylindrical cavity 12q and a half cylindrical cavity 34e of the section or plate 34 as will be explained further later in this application. A spring 32, shown in FIG. 12 is configured to fit partially within a bore or opening 30e of the device 30 and simultaneously partially within the half cylindrical cavity 12r and within a half cylindrical cavity 34s of section or plate 34 shown in FIG. 15. The protrusion 12t shown in FIG. 12 and a protrusion 34t shown in FIG. 15, fit into indentations 30d shown in FIGS. 14A-B and indentation 30g shown in FIG. 12, respectively, to hold the device 30 in a fixed position when the folding knife 1 is completely assembled.

The folding knife 1 also includes a washer 14 which may be a flat washer made of nylon or metal, having an opening with a diameter allowing for the insertion of cylindrical body portion 2b of the pin 2. The washer 14 is used between the device 16 and the plate or section 12 to allow for smooth rotation of the device 16 from an open position to a closed position and back.

The folding knife 1 may also include the device 16. The device 16 may include a hook 16a, a notch 16b, an opening 16c, a post 16d, an opening 16e, a flat stopper surface 16f, and a slot 16g. In the assembled folding knife 1 in the position shown in FIG. 1, the stopper 21a contacts or flat stopper surface 16f to prevent the device from rotating any further clockwise from the position as viewed in FIG. 5. The slot 16g may be about one half inch in length L1 as shown in FIG. 5. A car seat belt, such as seat belt 300 shown by dashed lines in FIG. 5, can be inserted into the slot 16g, and the folding knife 1 and device 16 can be used to cut the seat belt 300 to get a driver out of a car after an accident. The device 16 includes a sharp hooked or U-shaped edge for cutting the seat belt 300.

The folding knife 1 may further include a washer 18 similar to the washer 14. The washer 18 has a central opening. The body portion 2b of the pin 2 can be inserted through the opening of the washer 18. The washer 18 is used on opposite side of the device 16 (from the side on which washer 14 is used) so that the device 16 can rotate smoothly from an open position to a closed position and back.

The folding knife 1 may further include a section or plate 20 having openings 20a and 20b. The opening 20a is sized so that the cylindrical body portion 8b can be inserted into the opening 20a. The openings 20b and 20c may be used for decorative purposes or may be used to align with openings 12d-e, 22b-c, and 34b-c, respectively, to properly align sections 12, 20, 22, and 34 with one another. The section or plate 20 may further include an opening 20d which is sized so that the cylindrical body portion 4b of the pin 4 can be inserted into the opening 20d. The section or plate 20 may further include a leaf portion 20e and a leaf portion 20f which are separated by a gap or channel 20g. The leaf portion 20f is separated from a leaf portion 20j by a gap 20k. The gaps 20g and 20k allow the leaf portion 20f to be flexed with respect to the leaf portions 20e and 20j. The leaf portion 20f includes a portion 20i and ridges 20h. The leaf portion 20j has openings 20l and 20m. One end of stopper 21a, for device 16 is inserted into opening 20l as previously mentioned. The cylindrical body portion 2b of the main pin 2 is inserted through opening 20m. The plate or section 20 also has ridges 20n which are used for decorative purposes. The section or plate 20 can be made of metal such as steel.

The portion 20i and ridges 20h are used as part of a liner lock. The ridges 20h add more friction when a user presses down on the leaf portion 20f shown in FIG. 11, to close the device 16, which may be called a rescue blade. When leaf 20f is raised up as in FIG. 11, the device 16 or rescue blade is in a ready to be used mode. When leaf 20f is pressed down, the device 16 or rescue blade can be closed, i.e. placed in the closed position of FIG. 3. Basically the leaf 20f is a liner lock used to engage or temporarily lock the device 16 or rescue blade in an opened state or to allow the device 16 to move to a closed state when the leaf 20f is pressed down.

In operation, the leaf portion 20f flexes outward away from the leaf portions 20e and 20j in order to keep the device 16 in an open position, i.e. prevent the device 16 from closing, as shown in FIG. 10. The leaf portion 20f, in one embodiment, must be pushed in so that it is co planar and aligned with the leaf portions 20e and 20j in order rotate the device 16 from an open to a closed position. The device 16 in the closed position holds the leaf 20f down so that it is substantially co-planar, aligned or most closely aligned with the leaves 20e and 20j then when the device 16 is in a closed position. The device 16 rotates about the cylindrical portion 2b of the pin 2.

The folding knife 1 may include a section or plate 22. The section or plate 22 may have an opening 22a, which when the folding knife 1 is completely assembled as in FIG. 1, aligns with the opening 20a and the cylindrical body portion 8b of the pin 8 can be inserted through the opening 22a. The section or plate 22 may also include openings 22b and 22c, wherein when the folding knife 1 is assembled as in FIG. 1, the openings 22b and 22c align with the openings 20b and 20c, but in one embodiment no screws are inserted into openings 22b-c and 20b-c. The section or plate 22 has an opening 22d which aligns with the opening 20d when the folding knife 1 is assembled as in FIG. 1. The cylindrical body portion 4b of the pin 4 is inserted into the openings 20d and 22d in order to assemble the folding knife 1 to be in the state of FIG. 1. The section or plate 22 includes leaf 22h and leaf 22e which are separated by a gap or channel 22g, which allows the leaf 22e to flex with respect to the leaf 22h. The leaf 22e has ridges 22f which are used to add friction. The leaf 22h has openings 22j and 22i. A stopper 21b is used to prevent the blade 26 from rotating further counter clockwise than the position shown in FIG. 4 and is insert at its one end into the opening 22j and at its other opposing end into an opening 34k of the plate or section 34. The cylindrical body portion 2b of the pin 2 is inserted through the opening 22i in order to assemble the folding knife 1 into the assembled condition of FIG. 1. The leaf 22h has ridges 22k. The section or plate 22 may be made of metal such as steel.

In operation, the leaf or leaf portion 22e flexes outwards from the leaf portion 22h in order to maintain the blade 26 in an open position, as shown in FIG. 9. In order to close the blade 26, in one embodiment, the leaf portion 22e must be pushed so that it is typically co-planar and aligned with the leaf portion 22h. When the blade 26 is in a closed position, the blade 26 holds the leaf portion 22e so that it is co-planar with, aligned with, or more aligned with leaf 22h, than the leaf 22e is when the blade 26 is in the open position.

The folding knife 1 may also include a washer 24 as shown in FIG. 15. The washer 24 is used between the blade 26 and the section 22 to allow the blade 26 to rotate smoothly from an open position to a closed position and back.

The folding knife 1 may further include the blade 26 having a mark (opposite the pin or post location) 26a, a hole 26b, a sharp edge 26c, and a post or protrusion 26d shown in FIGS. 8 and 9. The opening 26b, shown in FIG. 15, has a large enough diameter for the insertion of the cylindrical body portion 2b of the pin 2. When the folding knife 1 is completely assembled the blade 26 can rotate about the pin 2. The blade 26 also has a flat stopper portion 26e which contacts the stopper 21b when the blade 26 is in the open position of FIG. 2, and which prevents the blade 26 from rotating any further counter clockwise from the position shown in FIG. 4.

The folding knife 1 may also include a washer 28 as shown in FIG. 15. The washer 28 is used between the blade 26 and the section 34 to allow the blade 26 to rotate smoothly from an open position to a closed position and back.

The folding knife 1 may include the section 30. The section 30 includes substantially cylindrical body portions 30b and 30c. The substantially cylindrical body portion 30b has a slot 30a shown in FIG. 15 and an opposite slot 30f shown in FIG. 12. The substantially cylindrical body portion 30c has an indentation 30d shown in FIG. 15 and an opposite indentation 30g shown in FIG. 12. The section 30 has a central opening or bore 30e at one end of the substantially cylindrical body portion 30c. The bore 30e has a diameter which is larger than the outer diameter of the spring 32 so that one end 32b of the spring 32 can be inserted into the opening or bore 30e. The device 30 includes a piston or rod 30h having a protrusion or pin 30i. The substantially cylindrical portion 30b can be pushed into the substantially cylindrical portion 30c as shown by FIGS. 12 and 13, until the substantially cylindrical portion 30b is completely within a hollow cavity within the substantially cylindrical portion 30c and until the protrusion or pin 30i protrudes from the bore 30e as shown in FIG. 13. The piston or pin 30i in inserted at the end 32b into the central opening 32a of a winding at end 32b. Thus when the portion 30b is pushed in, the spring 32 is pushed and when inside of the housing 1a in the assembled knife 1 is compressed as will be described later.

The spring 32 is inserted so that the circular openings 32a of the windings of the spring 32 are penetrated, at least partially by the piston or post 30i. The end 32c of the spring 32 impacts an inner wall 34s when the folding knife 1 is assembled. The section 30 has an inner spring, not shown, inside of substantially cylindrical portion 30c. The inner spring biases the section 30 into the state shown in FIG. 12, where the portion 30b is extended outside of the portion 30c. Force must be applied in the direction D2, shown in FIG. 16A in order to push the portion 30b into the portion 30c and to put the section 30 into the state shown in FIG. 13. An individual can supply such force by gripping the knife 1 and hitting a glass material 100 of a vehicle, such as windshield with the section 30. When the individual applies the force in the direction D1, upon impact, the glass 100 will apply a force in the opposing direction D2 to force the portion 30b back into the portion 30c. This force, in the direction D2, causes the inner spring, not shown of device 30 to compress and causes the spring 32 to compress. In this manner the device 30 and the folding knife 1 in general, can be used to break a vehicle material, such as a car windshield glass material. FIG. 16B shows that the portion 30b has been pushed into the portion 30c.

The folding knife 1 may also include the section or plate 34. The section or plate 34 may have holes or openings 34a, 34b, and 34c. The opening 34a aligns with the openings 20a, 22a, and 12b and the cylindrical body portion 8b of the pin 8 is inserted simultaneously into the openings 12b, 20a, 22a, and 34 in the assembled form of the folding knife shown in FIG. 1. The section 34 may have hole or opening 34f which aligns with hole or opening 12a and through which cylindrical body portion 6b is inserted in the assembled form of the folding knife 1 shown in FIG. 1. The section or plate 34 also has substantially semi-circular cylindrical cavity 34e into which about half of the portion 30c of device 30 fits, as shown in FIGS. 14A and 14B. The section or plate 34 also includes ridges 34n, which align with ridges 12h of section or plate 12 when the folding knife 1 is in the assembled form shown in FIG. 1. The section 30 also has an opening or bore 34h which aligns with openings 20d, 22d, and 12i and through which the cylindrical body portion 4b of the pin 4 is inserted in the assembled form shown in FIG. 1. The section 34 also includes support ridges or members 34g which provide structural support for a force in the direction D2 shown in FIGS. 16A and 16B which cause section 30b to be forced back into portion 30c. The section 34 includes an opening or indentation 34l which aligns with the opening in the washer 28, opening 26c, the opening in the washer 24, opening 22i, opening 20m, the opening in washer 18, opening 16b, the opening in washer 14, opening 12m, and opening 10g and into which the cylindrical body portion 2b of the pin 2 is inserted to form the assembled form of the folding knife 1 in FIG. 1. The section 34 may include a top surface plate 34n which may be screwed into a bottom surface plate 34o by screws or bolts 34i and 34j. The top surface plate 34n may be made of metal such as steel or zinc, and the bottom surface plate 34o may be made of a hard stiff material, such as a hard stiff plastic.

The section 34 includes a push button or toggle switch 34b shown in FIG. 3. The push button or toggle switch 34b when pressed causes an LED light 34m to change state. If the LED light 34m was in an off state, then pressing the button 34b causes the LED light 34m to go on. If the LED light 34m was in an on state then pushing the push button 34b causes the LED light 34m to turn off. Circuitry inside of the section 34 may electrically connect the LED light 34m with a battery located under portion 34q shown in FIG. 3. The portion 34q can be taken off by unscrewing a screw or bolt 44 also shown in FIG. 10 to reveal an inner battery for powering the LED light 34m

The folding knife 1 includes screw or bolt 38 which is screwed into a hollow inner threaded opening of cylindrical body portion 6b to hold sections 12 and 34, and the folding knife 1 in general, together in the assembled form of FIG. 1. In the assembled form of the folding knife 1 of FIG. 1, the cylindrical body portion 6b lies inside of openings 12a and 34f.

The folding knife 1 also includes spacers 19a, 19b, 19c, and 19d, each of which may be a metal ring. The spacers 19a and 19b lie between section 12 and 20, and space sections 12 and 20 apart. Cylindrical body portions 8b, and 4b of pins 8 and 4 are inserted through the spacers 19a and 19b, respectively. The spacers 19c and 19d lie between sections 34 and 22 and space sections 34 and 22 apart. Cylindrical body portions 8b and 4b of pins 8 and 4, respectively, are inserted through the spacers 19c and 19d, respectively.

Also provided are screws or bolts 36, 40, and 42 which screw into hollow inner threaded openings of cylindrical body portions 8b, 4b, and 2b, respectively, to hold sections 12 and 34, and the folding knife 1 in general, together. In the assembled form of the folding knife 1 of FIG. 1, the cylindrical body portion 8b lies inside of openings 12b, 20a, 22a, and 34a (which are aligned with each other) to connect the sections 12, 20, 22, and 34 together. In the assembled form of the folding knife 1 of FIG. 1, the cylindrical body portion 4b lies inside of openings 12i, 20d, 22d, and 34h (which are aligned with each other) to connect the sections 12, 20, 22, and 34 together. In the assembled form of the folding knife 1 of FIG. 1, the cylindrical body portion 2b lies inside of openings 10g, 12m, the opening of washer 14, 16c, the opening of washer 18, 20m, 22i, the opening of washer 24, 26c, the opening of washer 28, and 34l (which are aligned with each other) to connect the components 10, 12, 14, 16, 18, 20, 22, 24, 26, 28, and 34 together, in a manner which allows the device 16 and the blade 26 to pivot about cylindrical body portion 2b.

FIGS. 16A-B show a hand 200 of a person gripping the folding knife 1, while the folding knife 1 is in a closed state, and with the hand 200 applying a force in the direction D1 at a car windshield 100 to break the windshield. Force is applied in the direction D1 in FIG. 16A, so that the front surface 30j of the portion 30b of the section 30 impacts with the windshield 100 with sufficient force to break the windshield 100. The collision of the windshield 100 with the section 30 shown in FIGS. 16A-B, causes the portion 30b to go into the portion 30c in the direction D2 and to compress the spring 32 as shown by FIG. 16B in conjunction with FIG. 14B. FIG. 14B shows the spring 32 compressed into the substantially semi-circular cylindrical cavity 34r. The spring 32 is a high compression spring. Portions 30b and 30c of section 30 may be made of a hard plastic material. When the portion 30b is pushed in the direction D2, the portion 30b is pushed into the portion 30c, and the portion 30b pushes the piston or rod 34h into the spring 32 causes the spring 32 to push against the wall 34s, which causes compression of the spring 32 shown by the combination of FIGS. 14A-B, FIG. 15, and FIGS. 16A-B. The wall or inner surface 34s is made of a hard material such as a hard plastic and is reinforced by members or rails 34g.

When the knife 1 is assembled, the portion 30c sits in a substantially cylindrical cavity or compartment comprised of substantially semi-circular cavity 34e of member 34, on the bottom, shown in FIG. 15, and substantially semi-circular cavity 12q of member 12 shown in FIG. 12, on the top. The portion 30c is held in the cavity comprised of 34e and 12q by protrusions 12t and 34t which are inserted in indentations 30g and 30d, respectively.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a housing;
a knife connected to the housing, wherein the knife at least partially folds into the housing; and
a first device for cracking a vehicle windshield, wherein the first device is connected to the housing.

2. The apparatus of claim 1 further comprising
a second device for cutting a vehicle seat belt, wherein the second device is connected to the housing and at least partially folds into the housing.

3. The apparatus of claim 1 wherein
the knife is connected to the housing so that the knife rotates in order to at least partially fold into the housing.

4. The apparatus of claim 1 wherein
the first device includes a first spring so that the first device can be compressed into the housing or expanded away from the housing.

5. The apparatus of claim 2 wherein
the second device is connected to the housing so that the second device rotates in order to at least partially fold into the housing.

6. The apparatus of claim 1 wherein
the first device includes a first member, and wherein the first device is configured with respect to the housing so that in a rest state, the first member protrudes out from the housing;
and wherein the first device is configured with respect to the housing so that a force can be applied to the first member which pushes the first member at least partially into the housing and which causes the first spring to compress.

7. The apparatus of claim 6 wherein
the first device includes a second member; and
wherein the first member is connected to the second member and the first member is configured to slide into the second member when the force is applied to the first member which pushes the first member at least partially into the housing.

8. The apparatus of claim 7 wherein
the first member is substantially cylindrical and the second member is substantially cylindrical.

9. An apparatus comprising:
a housing;
a knife connected to the housing, wherein the knife at least partially folds into the housing; and
a first device for cutting a vehicle seat belt, wherein the first device is connected to the housing and at least partially folds into the housing.

10. The apparatus of claim 9 wherein
the first device is connected to the housing so that the first device rotates in order to at least partially fold into the housing.

11. The apparatus of claim 10 wherein
the first device includes a U-shaped cutting edge located within an interior of a hook.

12. A method comprising
gripping an apparatus using a person's hand; and
hitting a vehicle windshield with the apparatus while gripping the apparatus using the person's hand;
wherein the apparatus includes:
a housing;
a knife connected to the housing, wherein the knife at least partially folds into the housing; and
a first device for cracking a vehicle windshield, wherein the first device is connected to the housing.

13. The method of claim 12 further comprising
cutting a vehicle seat belt using a second device of the apparatus;
wherein the second device is connected to the housing and at least partially folds into the housing.

14. The method of claim 12 wherein
the knife is connected to the housing so that the knife rotates in order to at least partially fold into the housing.

15. The method of claim 12 wherein
the first device includes a first spring so that the first device is compressed into the housing when the first device contacts a vehicle windshield or expanded away from the housing when the first device is not in contact with any object.

16. The method of claim 13 wherein
the second device is connected to the housing so that the second device rotates in order to at least partially fold into the housing.

17. The method of claim 12 wherein
the first device includes a first member, and wherein the first device is configured with respect to the housing so that in a rest state, the first member protrudes out from the housing;
and wherein the first device is configured with respect to the housing so that a force can be applied to the first member when the first member contacts a vehicle windshield which pushes the first member at least partially into the housing and which causes the first spring to compress.

18. The method of claim 17 wherein
the first device includes a second member; and
wherein the first member is connected to the second member and the first member is configured to slide into the second member when the force is applied to the first member which pushes the first member at least partially into the housing.

19. The method of claim 18 wherein
the first member is substantially cylindrical and the second member is substantially cylindrical.

20. A method comprising
gripping an apparatus using a person's hand; and
cutting a vehicle seat belt using a first device of the apparatus;
wherein the apparatus includes:
a housing;
a knife connected to the housing, wherein the knife at least partially folds into the housing; and
the first device, wherein the first device is connected to the housing, and at least partially folds into the housing.
